(19) United States
(12) Patent Application Publication
(10) Pub. No.: US 2013/0022953 A1
(43) Pub. Date: Jan. 24, 2013

(54) METHOD AND PLATFORM FOR OPTIMIZING LEARNING AND LEARNING RESOURCE AVAILABILITY

(71) Applicants: Wim J. van der Linden, Monterey, CA (US); Qi Diao, Salinas, CA (US); Jie Li, Seaside, CA (US)

(72) Inventors: Wim J. van der Linden, Monterey, CA (US); Qi Diao, Salinas, CA (US); Jie Li, Seaside, CA (US)

(73) Assignee: CTB/McGraw-Hill, LLC, Monterey, CA (US)

(21) Appl. No.: 13/546,542

(22) Filed: Jul. 11, 2012

Related U.S. Application Data
(60) Provisional application No. 61/506,523, filed on Jul. 11, 2011.

(51) Int. Cl. G09B 5/00

(52) U.S. Cl. 434/322

(57) ABSTRACT

A platform and method for improving learning within a learning model uses a mathematical optimization algorithm to maximize learning gains through efficient resource allocation that accounts for practical constraints, such as teacher or other resource availability, and probability of success for individual learners on learning nodes given learner profile and resource and instructional configurations. One practical output from this platform and method is a schedule that contains an assignment of learners to learning nodes and teaching resources by learning session over the course of several days.

This application claims the benefit under 35 U.S.C. §119(e) of U.S. Provisional Application No. 61/506,523, filed Jul. 11, 2011, the disclosure of which is hereby incorporated by reference in their entirety.

### BACKGROUND

The educational literature suggests that for classrooms to be successful, teachers must have a deep understanding of content, vary instructional techniques and modalities, use formative assessment to monitor progress, and then know what to do with all the information. However, even good teachers find it difficult to implement these types of suggestions in their classrooms. Further, some schools constrain the pace of instruction, regardless of individual student progress.

Accordingly, in spite of the general belief that individualized instruction leads to better achievements than group-based teaching, most educational reforms that have attempted to introduce individualized instruction systems have dramatically failed because of the organizational and logistic complexities of such systems. The present invention illustrates how such a system can be designed and optimized, taking some or all management decisions out of the hands of the instructors. The present invention comprises a platform which employs an optimization algorithm or heuristic to assign students to combinations of content nodes (e.g., skills), instructional modalities (e.g., computer-aided instruction, group-based instruction, remedial teaching, virtual tutoring, etc.), teachers, groups, classrooms, as well as other instructional resources on the basis of designations of mastery (partial mastery, non-mastery, mastery) of the node, through assessment results, teacher indications, or other evidence. Partial mastery includes mastery based on a cumulative body of evidence for each individual student. It also includes mastery that is represented on a scale (e.g., IRT scale). Input to the platform includes: metadata representing a learning model in the form of a directed graph with content units or skills as nodes and interconnected to one another through graphically and/or functionally expressed pre- and post-cursor relationships, metadata representing a student profile, and metadata representing instructional resource availability. Output from the platform includes data showing assignment of students to combinations of nodes (e.g., skills) and resources representing the optimal distribution of students to resources for the learning session. The optimal distribution is based on maximizing the total expected learning gain (i.e., utility) for the group of students to be scheduled for the learning session. Output data may be represented in any format suitable for communicating data to a user (e.g., user interface, csv file, database query). An optional component of the platform is an additional optimization algorithm or heuristic to identify assessment items from an assessment item pool and/or an optimization algorithm or heuristic to identify instructional resources from a pool of instructional resources aligned with the assigned content node.

### BRIEF DESCRIPTION OF DRAWINGS

The novel features characteristic of the invention are described in detail below. However, the invention may be better understood by reference to the following Figures wherein:

FIG. 1 is a schematic overview of the automated assignment platform;

FIG. 2 is an object model representing data objects employed in an embodiment of the platform

FIG. 3 is a schematic illustrating the interplay between two automated assignment platform components

FIG. 4 is a schematic overview of an alternative embodiment of the automated assignment platform;

FIG. 5 is a schematic overview of the data pre-processing module;

FIG. 6 is a schematic depicting the interplay between modality assignment and mastery or non-mastery of a learning node;

FIG. 7 is an example of a learning model;

FIG. 8 is a flowchart generalizing the steps that occur during each learning session.

### DETAILED DESCRIPTION

Learning Content

The automated assignment platform is agnostic as to any specific content area, grade level, or granularity; rather, it utilizes metadata related to nodes (e.g., content units or skills) a learner is expected to gain during the course of instruction. The metadata, in combination with the student profile, is used to determine which nodes are appropriate for any one student to learn next. There is no limit to the number of nodes the platform can accept, and the platform can also consider and prioritize subgroups of nodes (i.e., strands) as needed. Metadata includes an identifier for each node, identification of pre- and post-cursor nodes for each node, identification of node membership to any subgroups of nodes, and preferred priority of any subgroups of nodes. In the context of the present invention, pre-cursor nodes are those nodes a student should be exposed to prior to a given learning node, and post-cursor nodes are those nodes a student should be exposed to after a given learning node. In the context of the present invention, the term student will be understood to encompass any individual who is engaged in learning, and is not limited to only those individuals who are enrolled in a school or college. For example, and without limitation, a student may be an individual engaged in corporate training, non-degree post-secondary training, personal enrichment courses, professional continuing education, standardized test preparation courses, adult education, subsequent language learning, or distance learning. In this context, the term “student” may be considered to be synonymous with the term “learner” unless the context suggests otherwise.

The metadata is typically associated with a learning model. Learning model is a term that encompasses learning progressions, learning maps, or any content to be learned that may be expressed through interrelations between topics, or learning targets, such as pre- and post-cursor relationships. Learning models have been previously described in the prior art, for example in U.S. application Ser. No. 11/842,184 (US Patent Application Publication No. 2007/0292823) which is incorporated by reference into the present disclosure. In one embodiment, a single learning model is applied to all students. In alternative embodiments, there may be a number of learning models correlating to the number of students to be scheduled. In another embodiment, the automated assignment platform of the present invention makes use of a learning model comprised of hypothesized and/or empirically derived learning target (i.e., node, skill) dependencies. However, as described above, an important feature of the automated assignment platform embodied in the present invention is that it is learning model-agnostic. Learning model-agnostic means it may incorporate content based on any learning model, i.e., the learning model used by the invention may be any set of learning nodes (e.g., topics, learning targets, etc.) identified by the user of the platform. In one embodiment, the learning model may be defined by alignment to federal, state, or other content standard (e.g., similar to approaches proposed by state assessment consortia). Alternatively, it may be defined by empirical research conducted in university or school settings. It may also be defined through the scope and sequence of the user's curriculum, a curriculum specialist, or a vendor. A person of ordinary skill in the art will appreciate that a novel element of the automated assignment platform is that any learning model defined by interrelations among learning topics, such as pre-cursor and post-cursor nodes, may be used.

In one aspect, a learning model enables a user to define learning targets (e.g., skills, knowledge) and the relationships, such as probabilistic and/or pre-cursor and post-cursor relationships, between or among them. It should be noted that the use of the given relationships in this invention may adhere to definitive rules, such as “a student may not progress to a post-cursor node until he/she has mastered all pre-cursor nodes,” or probabilistic relationships may be used, such as “a student will have a 54% chance of mastering this node if the pre-cursor node has been mastered, and as such, should be given the opportunity to attempt the node.” These learning target definitions, combined with the probabilistic relationships, form a learning model. One or more types of relationships between learning targets may be used. One necessary relationship is the probabilistic order in which the learning targets are mastered. For example, a first learning target could be a pre-cursor to a second learning target. In one embodiment, when a first learning target is a pre-cursor of a second learning target, it is implied that the knowledge of the second learning target is dependent on the knowledge of the first learning target. It is not required that all learning model nodes are related in a linear fashion, or that the nodes or relationships remain constant from one scheduling period to another, or that the nodes or relationships remain constant when applied to different student profiles for determination of available nodes. It should be emphasized that the learning models used in the present invention may be acyclic. Therefore, the first learning target could be a post-cursor to (learned after) a third learning target. If a first learning target is a post-cursor of a third learning target, knowledge of the first learning target implies knowledge of the third learning target. Similarly, the second and third learning targets could have pre/post-cursor relationships with other learning targets. Using these relationships, the targets may be structured into a network of targets (or nodes) in an acyclic directed network, such that no node can be the pre-cursor or post-cursor of itself either directly or indirectly. The order of the targets in the learning model is such that if there is a path between the two learning targets, there may be one or more additional paths between them.

These paths may be mutually probabilistically exclusive (i.e., if a learner progresses through one path, he/she is not likely to progress through another), they may be mutually probabilistically necessary (i.e., a learner is likely to need to progress through all of the paths), or only some subset of the paths may be necessary (i.e., if a learner goes through a given path, he/she is likely to go through some other path as well). These probabilities of path traversal may be expressed as Boolean or as real numbers.

Advantageously, the accuracy of a learning model can be determined based on item response information provided to the platform. For example, a test platform (e.g., Acuity, available from CTB/McGraw-Hill) may export results from a learning target assessment to the learning model in order to validate the results. Results are an indication of student mastery of the learning target. The results in turn validate the relationship between the nodes. It should be emphasized that the present invention is testing and technology platform-neutral. Multiple learning models, each calibrated by the data stream from test administrations to variations in the learning sequence and targets of different subpopulations, can be maintained simultaneously and compared or used separately. Students might be associated with more than one learning model; for example, a student who is gifted and female might be associated with both a model based on a gifted population and a model based on a female population.

Integration with a Management System

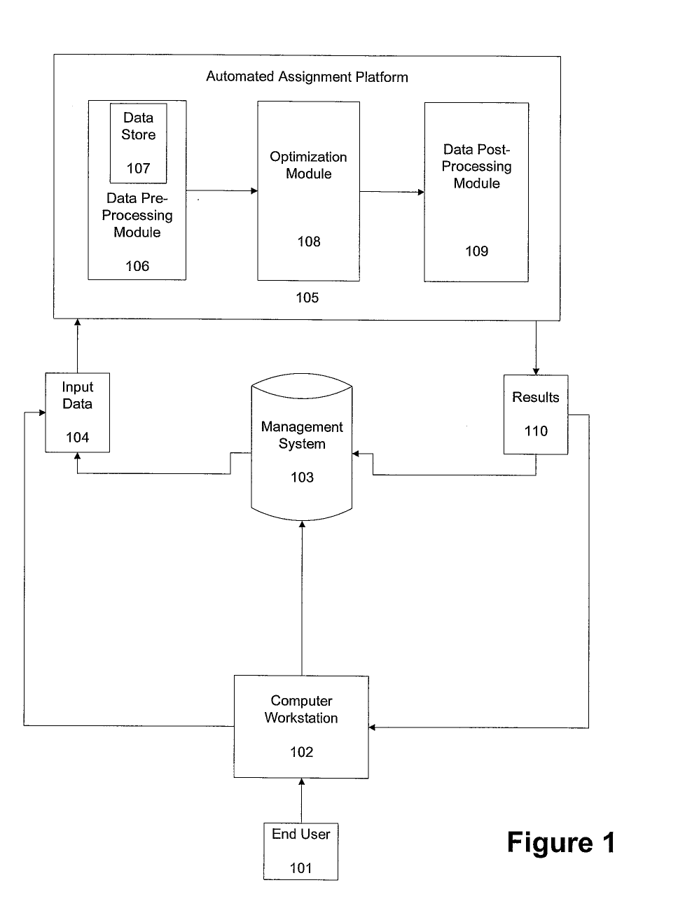

The automated assignment platform of the present invention may work in concert with a management system (for example, a school information system or a learning management system) or may be implemented directly through simple file transfer (such as Excel), web service, or other data transfer mechanism from a computer hosted by the user to the platform. If a management system is used, such a system may host a content library and allow teachers to view the available lessons in response to the schedules generated by the optimization algorithm. In other words, the management system may serve as a conduit through which all the learning models, student progress and assessment data, lessons, and results of optimization algorithms are presented to the end user. Alternatively, the end user can directly submit data to the assignment platform and receive data from the assignment platform via file transfer (e.g., comma-separated file, Excel file, xml file). A graphical representation of such a platform is shown in FIG. 1.

FIG. 1 provides a schematic representation of the automated assignment platform 105 as integrated with a management system. It will be understood that FIG. 1 is intended only to provide a visual representation of one embodiment of the present invention, and is not intended to assert or imply any limitation with regard to different embodiments that may be implemented. In this Figure, an end user 101 interfaces with a computer workstation 102. The end user 101 may be an educator, student, parent, administrator, or any other entity interacting with the automated assignment platform. The computer workstation 102 in turn is capable with interacting with a management system 103. A management system 103 may be embodied by a school information system, learning management system, or any other network or software application for the administration, documentation, tracking, and reporting of training programs, classroom and online events, e-learning programs, and training content. It should be emphasized that the automated assignment platform 105 embodied by the current invention does not require the use of a management system 103. Instead, as depicted in FIG. 1, the end user 101 may interact with the automated assignment platform by direct file transfer or other data submission 104 and 110 from the computer workstation 102.

Assignment Platform

In FIG. 1, an input data file 104 interacts with the automated assignment platform 105. As shown in FIG. 1, the input data file 104 may originate directly from an end user 101 via a computer workstation 102 or may originate from a management system 103. The input data file may include without limitation the desired learning model, resource constraints, student identifier, and preferences. A person of ordinary skill will recognize that any other data useful in assisting the automated assignment platform in optimizing a solution may also be properly termed input data. The input data may be delivered to the automated assignment system 105 through a web service, file transfer, or other data transfer. Further details regarding input data are found under the heading “Input” below.

The automated assignment platform 105 in this invention consists of multiple modules: the data pre-processing module 106, the optimization assignment module 108, and the data post-proces sing module 109. A person of ordinary skill in the art will recognize that the automated assignment platform is capable of integrating a variety of additional modules. For example, alternative embodiments of the automated assignment platform may optionally comprise a module that optimally selects assessment items from an item bank for the assigned node, or a module that optimally assigns lessons from a lesson bank may also be included. Persons of ordinary skill will recognize that these are non-limiting optional embodiments. Further, the automated assignment platform of the present invention is not limited to only a single optional module.

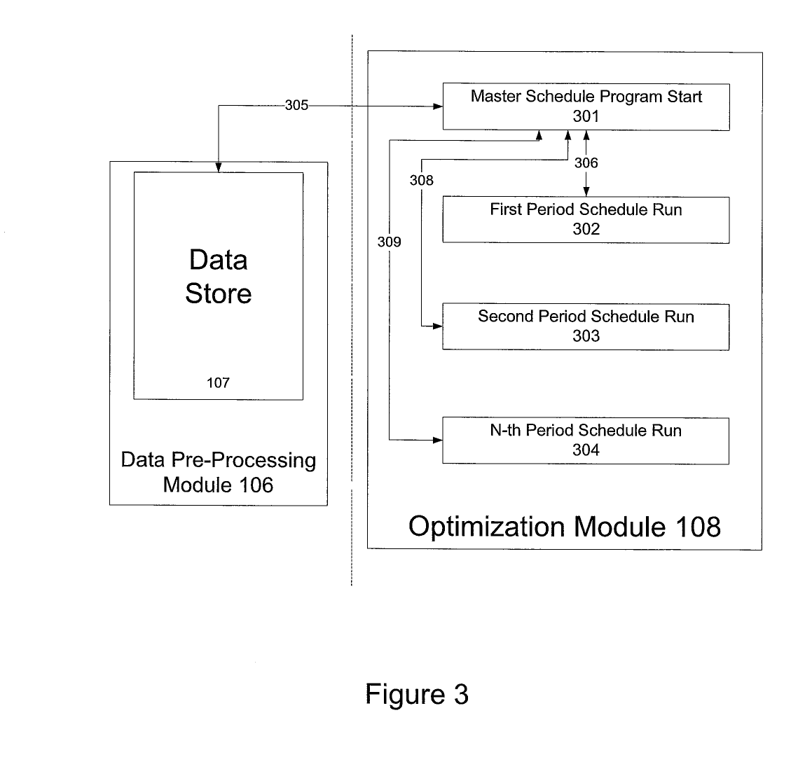

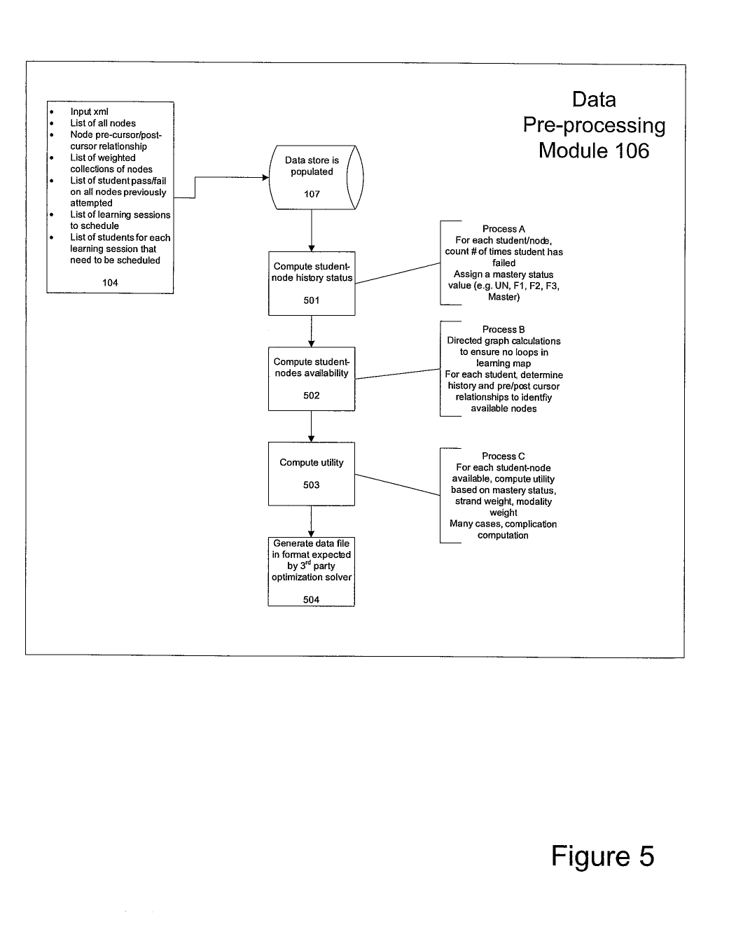

The data pre-processing module 106 completes several processes culminating in a set of files in the format expected by the optimization model. One embodiment of these processes is illustrated in FIG. 5. First, the module processes the student/node mastery history such that a mastery status may be assigned for each student for any node in the learning model 501 (Process A). Based on this information, the module then computes which nodes in the learning model should be made available to each student during optimization routines 502 (Process B). The module then computes a utility, also referred to as a learning gain, for each combination of available student-node modality 503 (Process C). The utility may be thought of as a weight indicating the likelihood of success the student will have on that node in that modality, given the student profile, student-node mastery history, pre- and post-cursor relationships, and other pedagogical considerations. Negative utilities are assigned for combinations that are not desired by the user (e.g., independent work the first time a student is assigned a particular skill) and serve as penalties during optimization. Further discussion of the calculation of utility is located below in the section describing data pre-processing in detail. The data pre-processing module then generates files in the format expected by the third-party optimization solver 504 for computation of the optimal schedule, i.e., the schedule that maximizes the sum of utilities (learning gains) across all students scheduled for a given learning session. The data pre-processing module may include a data store for storage of the above-discussed data 107. Graphical user interfaces (GUIs), views, and/or queries may be used to view the data. As indicated above, the data pre-processing module performs routines in preparation for data submission to the optimization assignment module 108 and may optionally apply constraints, apply system rules, and/or launch data visualization and/or quality assurance tools. As depicted in FIG. 3, the data pre-processing module may also receive data from the optimal assignment module 305 to allow for scheduling of multiple learning sessions. The data pre-processing module is capable of being realized through any commonly known programming language, database, and technology. For example, a currently preferred embodiment is a library of Java code with an Oracle database. Further details regarding the data pre-processing module are given under the heading “Data Pre-Processing” below.

The optimization assignment module 108 utilizes the output of the data pre-processing module. It then generates an optimization problem, solved by a third-party solver, such as a mixed-integer programming solver in one embodiment. Results from the automated assignment platform 105 are post-processed by the data post-processing module 109 to generate consumable data 110 and are then returned either to the management system 103 or directly to the end user 101 via the computer workstation 102. The results may be represented by any data transfer system selected by the end user (e.g. a Microsoft Excel file) or by more sophisticated graphical user interfaces, as desired. Further details regarding the exported data are given under the heading “Exporting the Results” below.

In order to run schedules for multiple learning sessions based on the same input metadata, as may be desired by a school scheduling class periods or another entity scheduling learning sessions for a given day, the optimization assignment module 108 consists of at least two parts: the master schedule program and the one-learning session schedule run program. A schematic illustrating these two parts and the interaction with the data pre-processing module is depicted in FIG. 3. Based on a single set of input data, the master schedule program 301 generates a schedule for the number of learning sessions indicated as desired in the metadata. Sessions in this context are defined as the smallest learning session unit. The master schedule program 301 retrieves current student and learning progression data 305 from the data pre-processing data store 107 identified above and generates data source files. The program then invokes the scheduling algorithm 306 using the one-period schedule run program 302-304. The one-period schedule run program calculates the assignment problem for one period only, for example the first period 302. The master schedule program 301 may monitor the solving process performed by the one-period schedule run program. The master schedule run program then receives the results 306 from the first-period schedule run program 302 and updates 305 the learning model database and any related graphical user interfaces, views, and queries in the data store 107. This is important because if the same student is to be scheduled for multiple learning sessions with one run of the optimization module, assumptions about the progress of that student in the first learning session may be made that impact the nodes made available for the next learning session. Therefore, during update, the master schedule program may apply probabilistic rules for assumptions of mastery of the nodes scheduled in the first session. The update step ensures that when the next period is calculated, each student will have a new set of available learning nodes, modalities, and other resources. The master schedule program will repeat the process 308-309 until scheduling for all desired sessions 302-304 has been calculated. The master schedule program may be run any number of times in a given period of time and is not limited to one run per day. A person of ordinary skill in the art will appreciate that the assignment module may be implemented in a number of ways, such as a Java library, a .DLL library, a stand-alone Windows application, or a Web service. A commercial or open-source mixed integer programming solver may be used to identify the optimal solution for the assignment problem presented by the one-period schedule run program should the desired optimization model require it.

Aspects of the present invention provide for a computer-implemented method, apparatus, and computer-usable program code for displaying information related to educational assignments for a group of students. A mathematical optimization algorithm is used to select an optimal decision set for assignments based on calculated student learning gains (also referred to as utilities). The mathematical optimization algorithm inputs information about students, including nodes available for the student based on mastery of learning model nodes and student profiles, resource constraints (e.g., available teachers and appropriately configured classrooms), and teaching modalities. The optimal decision set is displayed for the user.

The platform produces optimal assignments for an educational environment in which limited resources must be optimized across students to address the instructional and assessment needs of individual learners. The schedule may be generated after initial assessment of student skill mastery at the end of a learning session for one or more future learning sessions. Optional features of the platform are an automated test assembly module, which will generate an assessment for each student on the schedule based on his or her learning model history, and a learning resources assignment module, which will assign instructional resources in an optimal fashion.

The platform is learning model-agnostic, learning management system-agnostic, school information system-agnostic, and other data management system-agnostic. Exports of data from either of the above-referenced models and systems may be used as input, and data from the platform may be imported into those systems.

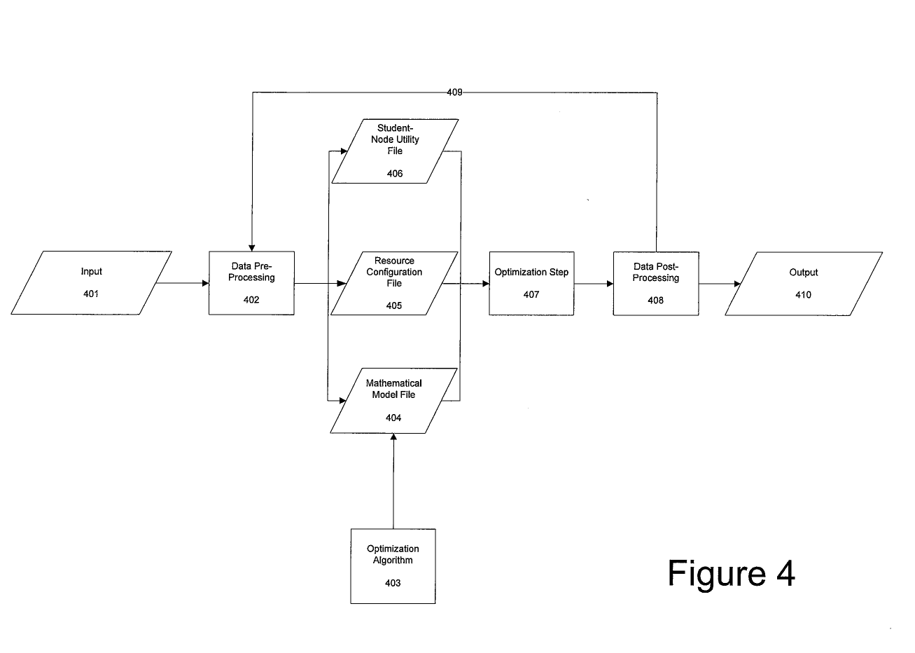

The platform consists of a series of components: input, data pre-processing, optimizing, data post-processing, and exporting results. FIG. 4 provides a schematic representation of another embodiment of the automated assignment platform. In this embodiment, input 401 interfaces with a data pre-processing module 402. The input 401 will include at a minimum a learning model, learning modality information, classroom information, student identification, and student learning node mastery information. Data pre-processing 402 includes identification of learning nodes available for individual students based on individual mastery records, identification of learning modalities available for individual students, and an assignment of utility for each combination of student, node, and learning modality. The assignment module controls the interaction between the mathematical model file 404, the student-node utility data file 406, and the resource configuration file 405. The mathematical model file 404 is the mathematical representation of the optimization algorithm 403 and includes both the mathematical formulas and configuration information required by the third-party optimization solver. 404, 405, and 406 are representations of the input data and mathematical model (e.g., a mixed-integer programming model) needed to be input into an optimization solution platform, such as a commercial solver. The optimization algorithm 403 comprises the various constraints to be considered and also the objective to be achieved by the automated assignment platform. The optimization step 407 solves the algorithm, in one embodiment, using a commercially available solver. Any commercially available solver may be used, although a currently preferred embodiment uses the IBM CPLEX solver. After the algorithm is solved there is a post-processing step 408. The post-processing step stores the assignment of learning model nodes and modalities to each individual student in both the data pre-processing data store (not depicted in FIG. 4, but see FIGS. 1 and 3) and an output file 410 for consumption by the end user. The data post-processing step may also form part of a loop 409 if multiple periods are being assigned to make the processing time more efficient.

A key feature of the present invention is that it is fully automated, with no need for human intervention after a model file is designed. However, the platform design also allows for user configuration in real-time. For example, the teacher may manually override the solution provided by the fully automated assignment platform in order to provide an alternative combination of variables.

Results from the automated assignment platform are obtained in real-time, as distinct from existing systems. The invention may be run automatically or upon demand. For example, for scheduling one hundred students, six modalities, eight classrooms, and various other configuration constraints, the results are typically obtained in less than three minutes per learning session. There is a great deal of flexibility built into the platform.

The design of the current invention reduces the chances of infeasibility. Infeasibility refers to the inability of the solver to find a solution. In one embodiment, the design is able to reduce the chance of infeasibility by leaving the choice to the end-user. This is referred to as the chose-optimization function and it minimizes the deviation from any of the constraints by issuing an ‘Unassigned’ status to any student for which all constraints cannot be met. For example, if there are only ten slots available for a particular modality at the school, but twelve students have profile and mastery status indicating that they require that modality on the only nodes they have available, then two students will need to be assigned to a different node or modality in violation of the resource constraints set by the end user. A person of ordinary skill in the art will recognize the chose-optimization function is programmed through common techniques used in the operations research field.

Input Data

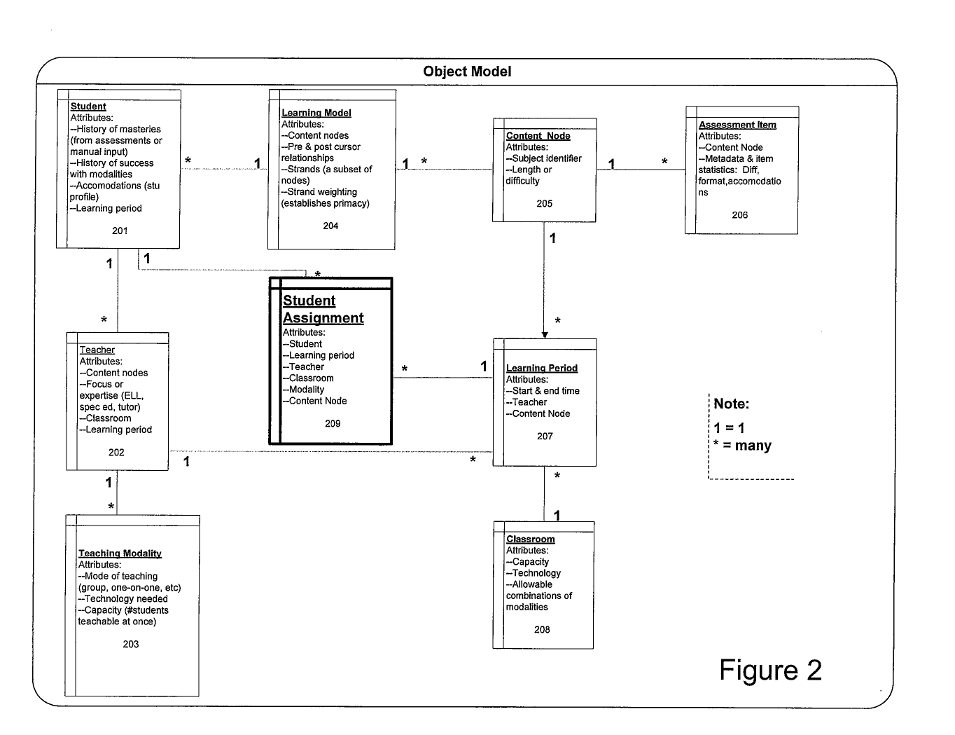

In one embodiment, input data to the platform includes the metadata represented in FIG. 2. A student 201 is an individual who has a learning map assigned to him or her, and will be given assignments for each of his or her learning periods. Teacher 202 is an individual who has from one to many learning periods 207 in which he or she instructs students by any of the modalities 203 at which he or she is skilled. Modality 203 is an instructional method often defined by minimum and maximum number of students, minimum and maximum number of skills, minimum and maximum number of teachers, and other required resources to deliver instruction in the modality (e.g., computers). Examples of modalities are group instruction, one-on-one tutoring, independent work or computer instruction without a teacher, various accommodation techniques, etc. A learning period 207 is a period of time for the teaching of one content node 205. A learning model 204 is a series of content nodes through which a student progresses, ordered by pre-cursor and post-cursor relationships. A content node 205 is one subject area. An assessment item 206 is a test item (test question or task). One to several assessment items may be associated with a content node, and they measure mastery of content nodes. Classroom 208 is a physical location in which instruction takes place for one or more learning periods. Classrooms are associated with various technologies and a student capacity. Student assignment 209 is one student 201 assigned to one learning period 207, which is in turn associated with a teacher 202, a classroom 208, a modality 203, and a content node 205. A series of these assignments, one or more per student, is the output of the invention, along with a set of assessment items 206 appropriate for measuring each content node. It is apparent to one of ordinary skill in the art that the platform is scalable to accommodate a wide number of students, different teaching modalities, learning periods, content nodes, and resource constraints.

The automated assignment platform eliminates the need to rewrite a new optimization model for every school by allowing users to customize the algorithm for a specific school environment through resource configuration specifications (input data). For example, one embodiment allows customization of modality (modality name, lower and upper bounds of the number of students allowed, lower and upper bounds of the number of skills allowed, lower and upper bounds of active classrooms), classroom (modality combinations permitted in the classroom), and teacher (name, availability, capacity). Prior to implementing the automated assignment platform at an educational site, input is gathered by identifying user-specific requirements through consultation with persons (e.g., educators) using the platform. Once user-specified parameters are defined and entered into the platform by the assignment platform operator(s) to generate the resource configuration file (FIG. 4, 405), the platform can run automatically whenever a schedule is desired. In a current embodiment, the operator enters the user-specified parameters manually to generate the resource configuration file. Examples of user-specified parameters include the number and names of available classrooms, the modalities available, the number of students, the name and number of available teachers, etc. These examples are represented in Tables 1 and 2 below.

TABLE 1
Modality Customization

| | | | | | | | No. of | No. of |
|---|---|---|---|---|---|---|---|---|
| | | | | | No. of | No. of | Active | Active |
| Modality | Short | | No. of | No. of | Skills | Skills | Classroom | Classroom |
| Index | Name | Long Name | Students | Students | LB | UB | LB | UB |
| 1 | TI | Teacher | 4 | 31 | 1 | 1 | | |
| | | Instruction | | | | | | |
| 2 | CI1 | Computer | 1 | 20 | 1 | | | |
| | | Assisted | | | | | | |
| | | Instruction | | | | | | |
| | | (when in | | | | | | |
| | | classroom with | | | | | | |
| | | TI) | | | | | | |
| 3 | CI2 | Computer | 1 | 32 | 1 | | | |
| | | Assisted | | | | | | |
| | | Instruction | | | | | | |
| | | (when in | | | | | | |
| | | classroom with | | | | | | |
| | | D5) | | | | | | |
| 4 | EE | Evaluation & | 1 | 12 | 1 | 3 | | |
| | | Enrichment | | | | | | |
| 5 | VT | Virtual Tutoring | 2 | 2 | 1 | | 1 | |
| 6 | UA | Un-assigned | | | | | | |
| | | dummy modality | | | | | | |

TABLE 2
Classroom/Teacher Customization
School ABC, Second Period: 8:55 AM-9:42 AM, 7&8 Pre-Algebra

| Classroom | | | | | Modality Combination | | | | |
|---|---|---|---|---|---|---|---|---|---|
| Index | Room | Name | Available | Capacity | 1 | 2 | 3 | 4 | 5, 6, . . . |

| | | | | | | | | |
|---|---|---|---|---|---|---|---|---|
| 1 | A7 | Mr. Smith | Y | 31 | TI | TI, CI1 | | |
| 2 | C12 | Mrs. Johnson | Y | 31 | TI | TI, CI1 | | |
| 3 | B5 | Mr. Williams | Y | 31 | TI | TI, CI1 | | |
| 4 | A20 | Mrs. Brown | Y | 31 | TI | TI, CI1 | EE | EE, CI1 |
| 5 | D5 | Mrs. Jones | Y | 32 | CI2 | CI2, VT | | |

Any changes in resource configuration may be passed to the platform through input data. The resource configuration data may be obtained via data export from a school information system, learning management system, or other system used by the school to track student progress or other student data. Input data may be delivered to the platform through either a file transfer or a data transfer. One embodiment is an xml file delivered to a secure file transfer protocol (FTP) site, but more direct forms of data transfer, such as a Web service, can be established and may be preferred.

Input data may also include information provided by a user or derived by the platform regarding teacher effectiveness in given modalities, learning nodes, or classroom settings, or with specific classroom technologies or resources. It is noted that teachers are often not interchangeable (for example, a special education teacher often has a different skill set than a high-school calculus teacher), and that differences in teacher resources may be accommodated by the platform through either user-configured or derived intelligent assignment of teachers to utility weights during data pre-processing. Other input data includes the desired learning model, which may be one per student, one per group of students, or one for all students, student identifiers, student mastery history on all nodes in the learning model, and any preferences to be used in utility calculations.

Mastery may be indicated either through teacher designation of mastery, or through assessment results. Assessments in this context are not limited to multiple choice tests, and may include bodies of evidence, performance tasks, and other mechanisms used to determine what a student knows and can do. Mastery through assessment may be, but is not limited to, indicated through pass/fail, application of cut-scores to produce multiple performance levels, or through scale scores. It should be noted that different modalities may have different requirements for mastery of pre-cursor or related nodes. For example, a cooperative learning group modality may be allowed for a student who has previously mastered the skill as a means of reinforcement or review. A person of ordinary skill in the art will recognize that the above example of input data is non-limiting, and that the automated assignment system of the present invention is compatible with a wide range of input data capable of delivery through file or data transfer.

The automated assignment platform is capable of working with a number of different instructional delivery methods. These instructional delivery methods are referred to as modalities. In one embodiment, there are four types of modalities such as cooperative learning group (“CLG”), independent work (“IW”), teacher instruction (“TI”), and virtual tutoring (“VT”). In addition, in some embodiments there may be an optional unassigned (“UNA”) modality reflecting instances when there is not a suitable modality available for assignment to a particular student. A person of ordinary skill in the art will recognize that the four modalities listed above are non-limiting, and any type of modality may be used. A person of ordinary skill will further recognize that it is possible to split the four general modalities listed above into multiple sub-modalities.

Although not intended to be binding definitions, the following are further descriptions of the above modalities. It is important to remember that any modality conforming to any description may be used in the automated assignment platform. It should also be noted that the platform does not place any limitations on the number of modalities to be assigned. In addition, the suggested numerical parameters recited in the following descriptions are not intended to be limiting, and a person of ordinary skill in the art will recognize that each modality is capable of being scaled up or scaled down as appropriate.

A Cooperative Learning Group may be a collaborative lesson, which may include games and projects, intended to provide conceptual review and/or skills practice for a small number of students ranging from about three to about ten students working as a group in the presence of a trained facilitator. Independent Work may be described as a lesson which provides conceptual review and/or skills practice to an individual student working at his/her own pace and using media that may range from pencil and worksheet to a computer game. Teacher Instruction is the traditional teacher-led lesson appropriate for class sizes of about two to twenty students and designed to provide instruction on a skill that is new to students. Virtual Tutoring is a teacher-led session for a single student conducted by a certified human teacher in an online, virtual environment such as over the Internet. This modality also may encompass without limitation avatar-based learning or artificial intelligence (AI)-based tutoring.

During input, all data is transferred to a data store. Several quality assurance checks may be built into this process. For example, resource constraints and preferences are compared against those established during configuration to determine whether they must be updated in the optimization model or not. Student mastery data is compared against that delivered in previous scheduling requests and against the previous schedule to identify students for whom mastery on nodes has changed and students who demonstrated mastery on skills other than those assigned by the algorithm for the previous period. Other embodiments include identification of students who were administered instruction in modalities other than previously scheduled and identification of students who were administered instruction by teachers other than previously scheduled. This identification becomes critical during data pre-processing, particularly for those data fields that will be used during the calculation of utility weight for each of the skill/modality/classroom/teacher combinations for a given student.

Data Pre-Processing

At least three distinct processes are implemented during data pre-processing in the current embodiment. This pre-processing is done through a series of custom programs (e.g., Java library). FIG. 5 shows the progression of these processes (identify nodes available for a given student 501, identify mastery status on each node 502, and compute a utility for each combination of student-node-modality 503. The output of data pre-processing is data 504 expected by the optimization module 108 that represents the utility (e.g., expected learning gain) for each student on each available learning model node in a particular modality. The computation of this utility is a critical aspect of this invention, as it allows the optimization module 108 to identify the solution for which the sum of utilities across students is maximized. For example, in Table 3, Student S5 has two nodes available (N3 and N4). The student has different mastery status for each of the two nodes, in which he has failed node 2 twice, and has not yet attempted node 4. Based on pedagogical preferences, the student is most likely to be successful in N3 if in a Teacher Instruction modality (utility=18), then next most likely to be successful in the Cooperative Learning Group modality (utility=16), then most likely to be successful in the Virtual Tutoring modality (utility=13). In addition, the student is most likely to be more successful in N3 (highest utility=18) than in N4 (highest utility=16), but depending on resource availability may be just as likely to pass N4 in Individual Work as N3 in Cooperative Learning Groups. The student is unlikely to pass if unassigned to either modality (utility=−100), and the platform will penalize a solution for with the student is unassigned. However, this penalty is necessary to prevent infeasibility. In addition, subject to all resource constraints given in the resource configuration file, student-node-modality configurations with higher utilities are more likely to be assigned.

TABLE 3
Sample Student Utility Weights for Different Nodes

| | | Node | | | Cooperative | | |
|---|---|---|---|---|---|---|---|
| Student | Node | Mastery | Teacher | Virtual | Learning | Individual | Un- |
| ID | ID | Status | Instruction | Tutoring | Groups | Work | Assigned |
| S5 | N3 | F2 | 18 | 13 | 16 | 0 | −100 |
| S5 | N4 | UA | 14 | 12 | 0 | 16 | −100 |

Several factors may be considered in the calculation of utility, including student profile, pedagogical preference, probabilistic relationships among learning nodes and learning node preferences, student mastery level, and so on. This novel design minimizes optimization run time and allows a great deal of flexibility. An example of rules related to pedagogical preference is given in Table 4.

TABLE 4
Modality Prioritization and Retake Policy

Students

| | First | Second | Third | Fourth | Fifth |
|---|---|---|---|---|---|
| Priority | Attempt | Attempt | Attempt | Attempt | Attempt |
| First | TI | TI* | TI** | EE | N/A |
| Second | CI | CI | VT | EE | N/A |
| Third | VT | VT | CI | EE | N/A |

TI Parameters
TI* - This class should consist of only students who are on their second to the extent that this is possible
TI** - This class should consist of only students who are on their third attempt to the extent that this is possible
CI Parameters
CI students working on the same skill should be grouped in the same classroom to the extent that this is possible
Block/Period Parameters
Block/Period Parameters “1A” and “1B” will contain the same students and teachers; the students will be assigned 2 different skills each day
Block/Period Parameters “2A” and “2B” will contain the same students and teachers; the students will be assigned 2 different skills each day

In one non-limiting embodiment, the rules used to identify the skills available for each student for the learning session are as follows:

Rule 1: Each node has one of four states for a given student at the end of a given learning session: Mastery (M), Failed Once (F1), Failed Twice (F2), and Unattempted (U). Note that additional states for a given student/node at the end of a given learning period are possible (e.g., F3—Failed three times).

Rule 2: The available nodes for the next day must meet two conditions: (1) The node is in the state: F1, F2 or U, and (2) The node is either the first node in a strand or the first node after a sequence of nodes with state Mastery (M). All nodes in all strands satisfying conditions (1) and (2) are the available set of nodes for the next session.

For example, an individual student's learning model, based on learning strands, may be represented as follows:

Strand1: N0(M)-N1(M)-N2(M)-N3(U)-N4(U)-N5(F1)-N6(M)-N7(U)-N8(U)-N9(M)-N10(F1)-N11(U)-N12(M)-N13(U)-N14(U)-N15(U)

Strand 2: S0(U)-S1(U)-S2(M)-S3(U)-S4(U)

In this example, and in accordance with Rule 1, nodes NO, N1, N2, N6, N9, N12, and S2 are designated as Mastered. Nodes N5 and N10 are designated Failed Once. The remaining nodes are Unattempted. Accordingly, by applying Rule 2, nodes S0 and N3 would be available for scheduling in this example. Also note that although the student learning model depicted above is in a linear progression, this is not a requirement for the present invention. In addition, in the example above, a ‘strand’ is a collection of nodes that may have rules associated with weighting of those nodes. For example, nodes in strand 1 may be more important to the curriculum, and as such, receive higher utilities than nodes in strand 2.

In this example, each modality is assigned a different positive number to reflect the relative impact of the modalities on the expected learning results; i.e., each modality is weighted. Subject to all relevant constraints, modalities with higher weights are more likely to be assigned.

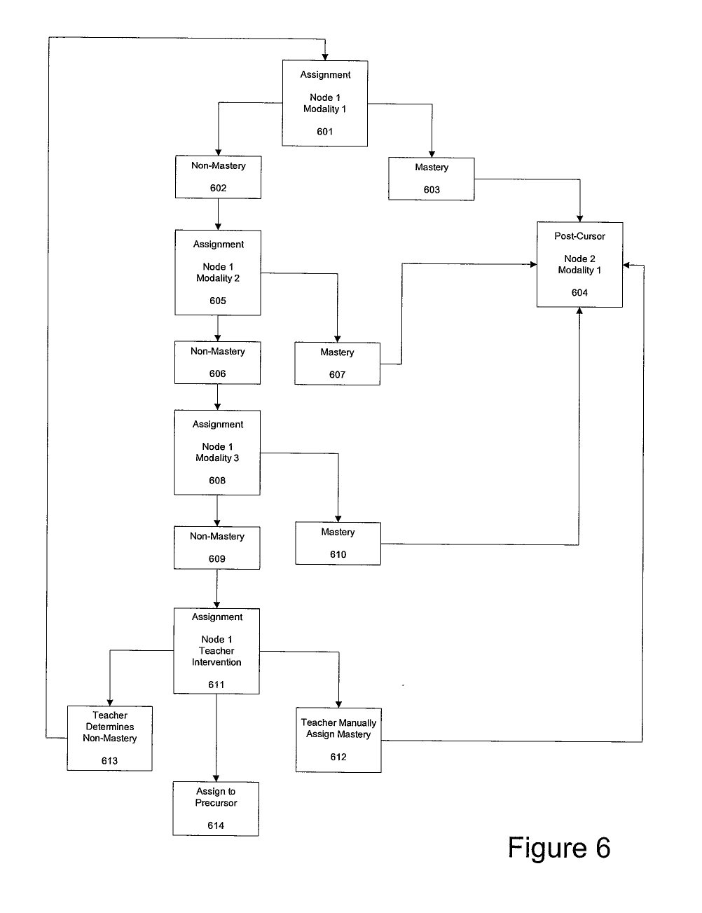

FIG. 6 is a schematic depicting an example of possible interplay between modality assignment and mastery/non-mastery of a learning node. In one embodiment, the default utilities for the modalities will be as follows: teacher instruction is weighted the highest, followed by virtual tutoring, cooperative learning group, and independent work, in that order. Once a student is assigned to a node 601 and fails 602, that modality will be down-weighted for subsequent retakes. For example, if the student was initially assigned virtual tutoring, the utilities for the first retake 605 could be: teacher instruction followed by cooperative learning group, followed by independent work, and then virtual tutoring. If the student is next assigned to teacher instruction and fails again 606, the order of modalities for the second retake 608 could be: cooperative learning group, followed by independent work, followed by virtual tutoring, and then teacher instruction.

If the student is unable to demonstrate mastery of the node following a third attempt 609, the student should then be assigned to a one-on-one intervention modality 611. In this modality, the teacher will need to diagnose the reason(s) for the student's non-mastery, i.e., a misunderstanding of the node itself, a missing pre-cursor skill set, etc. In any case, the teacher should work with the student individually to enable the student to master the node.

The teacher has three options in the above scenario. First, the teacher may manually assign mastery of the node within the platform based on the teacher's judgment and the intervention modality 612. If this occurs, the student will move on to the next node in the learning model as assigned via the algorithm. Second, the teacher may make a determination of non-mastery of the node, and send the student back to the node for retesting 613. If retesting in this case demonstrates mastery, then the student may be advanced to the next node as per the optimization algorithm. Third, the teacher may determine the issue is due to non-mastery of a pre-cursor node 614. In this case, the previously mastered pre-cursor node will be switched to “non-mastery” in the input data. When this occurs the algorithm will recognize the non-mastery of the pre-cursor node and return the student to complete the pre-cursor node and retest the student for mastery of the pre-cursor node. The platform allows the teacher to assign any pre-cursor node, i.e. the pre-cursor node assigned does not have to immediately precede the non-mastered node in the learning model. The pre-cursor node may precede the non-mastered node by an alternative path. Depending on the learning model used, the platform may automatically assign an alternate path.

Utilities are assigned to weight the likelihood of the scheduling algorithm making that assignment. A lower value will result in a less likely assignment. A much lower value will penalize the algorithm if the assignment is made, effectively preventing that assignment. For example, the following utilities may be assigned weights as follows:

Utility=w_{inms′}=a_{ims′}+bₙ+cₙ

In the above formula, i represents a student in the class, n represents a node in the learning model, m represents a modality, and s represents a time slot. a_{ims′} is a component of the weight for the modality. bₙ is a component that helps to assign weights to various paths through the learning model, and cₙ is a component assigned to nodes that have parallel post-cursors.

Parallel post-cursors occur when multiple post-cursors are associated with a single pre-cursor.

Sample output from the utility weight assignment is as follows:

Output

| | |
|---|---|
| −199 | Do not assign the student to this skill/modality/classroom |
| −99 | Least favorable possible combination of skill/modality/classroom |
| 2 | Next favored combination |
| 4 | Next favored combination |
| 8 | Next favored combination |
| 20 | Most favored combination. |

Note that these values are relative. The custom Java library is designed to allow the assigned utility weights to be configurable and adjustable whenever desired. Note that these utilities enable the scheduling algorithm to become more intelligent over time; for example, using data collected over the course of instruction to favor modalities a particular student is most successful in achieving mastery of nodes. Identification of the best path for a particular student through a particular learning model may be realized through analysis of data associated with the learning model, student profile, assessment results, and the utility weights. A combination of the data pre-processing and application of the optimization model will allow the weights to be adjusted in an automated fashion, e.g., through system training.

The data is then formatted into the input file for the optimization solver. Table 5 illustrates an example input file.

TABLE 5
Sample Output from Data Pre-Processing Module

| | | Modalities | | | | |
|---|---|---|---|---|---|---|
| Student | Node | TI | VT | CLG | IW | UNA |
| S1 | N1 | 6 | 2 | 15 | 0 | −100 |
| S1 | N2 | 2 | 3 | 5 | 1 | −100 |
| S2 | N1 | 36 | 3 | 0 | 0 | −100 |
| S2 | N3 | 12 | 4 | 15 | 19 | −100 |
| S2 | N5 | 14 | 12 | 0 | 10 | −100 |
| S3 | N1 | 18 | 13 | 16 | 0 | −100 |
| S3 | N7 | 14 | 15 | 11 | 0 | −100 |
| S4 | N2 | 18 | 13 | 4 | 0 | −100 |
| S4 | N6 | 14 | 21 | 7 | 0 | −100 |
| S4 | N5 | 24 | 21 | 7 | 0 | −100 |
| S4 | N8 | 4 | 21 | 7 | 0 | −100 |
| S5 | N3 | 18 | 13 | 16 | 0 | −100 |
| S5 | N4 | 14 | 12 | 0 | 16 | −100 |

The numerical values represent the learning gain (or utility) for each student for each node and each modality. In Table 5, student “S1” has two nodes available to study: “N1” and “N2”. If student “S1” studies node “N1” with modality “TI”, the learning gain is 6. However, if student “S1” studies node “N1” with modality “CLG,” then the learning gain is 15. Note the Un-Assigned learning gain is −100, which functions as a penalty to the learning gain if a student is not assigned to any node and modality.

This design offers several novel features. Note that the following illustrative examples are not necessarily tied to Table 5. One feature is that the user can decide which students to place into the algorithm. For example, if a student is absent, then no data row for that student is placed in the input file. Another feature is that the user can decide which nodes for the students are available. For example, if student “S3” has only one row in the input (e.g. “S3”, “N1”, [TI (18), VT (13), CLG (16), IW (0), UNA (−100)]) then Student “S3” will only study the node “N1” or Un-Assigned (modality “Un-Assigned” if there is no resource available). This is particularly useful if the user wants to overwrite temporarily or permanently any learning model rules (pre-/post-cursor). A third feature of this design is that the user can manipulate learning gain so that students can be assigned to a particular modality or modalities. For example, student “S3” can be assigned node “N1” with modality weights [TI (−999), VT (−999), CLG (200), IW (−999), Un-A (−100)]. In this case, student “S3” has been assigned to study node “N1” and to prefer “CLG”, and then “Un-Assigned”. The algorithm will never assign “S3” to “N1” with modalities “TI”, “VT”, or “IW.” A fourth feature is that the user can manipulate learning gain so that students can be assigned to a preferred node or nodes. For example, Student “S3” may have two possible nodes “N1” and “N2.” It is possible to assign modality weights such that “N1,” [TI (8), VT (5), CLG (6), IW (7), UNA (−100)] and “N2,” [TI (80), VT (50), CLG (60), IW (70), UNA (−100)]. In this case, it is preferred that student “S3” study node “N2” over node “N1”. The actual assignment will depend on the various constraints; however, the platform is likely to assign node “N2” unless that node conflicts with other constraints.

Optimizing

The optimization algorithm was developed to create an assignment schedule for teacher and student for either one period or multiple periods. It was developed to manage the assignment of students to skills within the learning progression, modality, classroom, teacher, and other resources. The algorithm's mathematical formulation includes various logistical and resource constraints. Non-limiting examples of such constraints include the number of students, the number of available teachers, the nodes available for each student to learn based on mastery of learning model nodes, the minimum and maximum number of students permitted for each modality, the number of computers available, the number of online tutors available for virtual tutoring, student mastery of daily assessments, the number of rooms available for instruction, etc. One embodiment of the algorithm uses mixed-integer programming to present the problem to the optimization solver. Any commercially available or open-source solver, such as IBM CPLEX or Gurobi, may be used to solve the algorithm. If desired, the optimization algorithm may be run on a server that is part of an integrated online management system.

As discussed above, during data pre-processing, each student/modality/node combination receives a utility. The utility is used to indicate the desirability of selection of that combination. The utilities are maximized over all possible student/modality/node combinations. The use of utilities in this fashion gives a great deal of flexibility in the data used to generate the utility. For example, in one embodiment, assessment mastery data and information about learning model node and modality preferences may be used. In another embodiment, the data such as student profiles or individual student learning histories may also be used. After the optimization algorithm is run, it produces a solution with the maximum sum of utilities. The objective of the optimization algorithm is to maximize both a major objective and a minor objective.

The major objective is to maximize all students' utilities (learning gain) over all possible student/modality/node combinations. The optimization algorithm may be embodied as follows:

$${\sum }_{s ∈ S} {\sum }_{n ∈ N ( s )} {\sum }_{m ∈ M ⋃ M 0} {\sum }_{r ∈ R} X [ s ] [ n ] [ m ] [ r ] * Utility [ s ] [ n ] [ m ]$$

Where the decision variables:

X[s][n][m][r]=1 if Student sεS is assigned to study node nεN(s) with modality MεM∪M0 in room rεR.

=0 otherwise.

and;

Utility[s][n][m] is from data pre-processing. A sample of the data output from this step is given in Table 1.

The minor objective is to make fine adjustments regarding student/modality/node under the same total utility (the major objective is met). Non-limiting examples of minor objectives include: (1) combining students with the same (modality, node) across the classrooms into a single classroom if possible; (2) if possible, avoiding the assignment of two or more modalities in a single classroom to prevent distraction of the teacher; (3) making adjustments to the number of nodes assigned under the same utility because some teachers prefer more node variety while others prefer less node variety. A person of ordinary skill in the art will recognize that the above examples of minor objections are non-limiting and are provided only for illustrative purposes.

Resource Constraints:

The methods described herein maximize the total value of the utilities defined in the data pre-preprocessing step for all of the student assignments subject to a series of constraints. Constraint data are added to reflect various constraints on the school and student assignments, such as physical space, staffing, educational level, and modalities. For example, the following constraint requires that the each student could only be assigned to a single node and a single modality and a single classroom in a learning period:

$${\sum }_{n ∈ N ( s )} {\sum }_{m ∈ M ⋃ M 0} {\sum }_{r ∈ R} X [ s ] [ n ] [ m ] [ r ] = 1 ∀ s$$

The following two sets of constraints requires that (1) the students assigned to that particular modality in that classroom do not exceed the maximal number allowed, and (2) a modality could only be active in a classroom that is configured to host that particular modality.

$$\begin{matrix}{\sum }_{s ∈ S} X [ s ] [ n ] [ m ] [ r ] \leq Modality\_Num \_of \_Student \_UB [ m ] * Active\_Room \_Modality \_Node [ r ] [ m ] [ n ] \\ ∀ r ∈ R ; ∀ m ∈ M ; ∀ n ∈ N ; & ( 1 ) \\ {\sum }_{c ∈ C} UseC [ r ] [ c ] * Room\_Modality \_Combination [ r ] [ c ] [ m ] == Active\_Room \_Modality [ r ] [ m ] \\ ∀ r ∈ R ; ∀ m ∈ M ; & ( 2 )\end{matrix}$$

The algorithm may be configured to take account of the upper bounds on each modality. For example, the number of students that may be assigned to the teacher instruction modality may be capped at an optimal number as determined by the teacher, school system, or overall resource availability. Similarly, a lower bound on an instructional modality may be set. In some embodiments the upper and lower bounds for a given modality will have the same numerical value. The algorithm may be configured to prevent assignment of the same node to a new group of students when an earlier group is not yet full. For example, if the modality is cooperative learning, the algorithm will not assign a second group of students to the same node as a first group of students when the upper bound of students within the first group has not yet been reached. A further constraint of room availability can also be factored into the modality upper and lower bound limitations. The limit on the number of rooms may be raised or lowered to reflect changing needs or availability. A person of ordinary skill will recognize that a wide variety of other constraints may also be modeled using common set notation. A person of ordinary skill in the art will also recognize the upper and lower bounds of the resource constraints are scalable to meet needs and availability. Accordingly, the above constraint examples are intended for illustrative purposes only.

Exporting the Results

Results are returned from the scheduling algorithm as a series of decision variables, as defined above. During post-processing, these results are reconfigured into a data store (e.g., Oracle) to retain the scheduled data.

Results may then be exported from the platform in a file transfer, Web service, or other mechanism commonly used for transfer of data. This data may be represented as an Excel file, csv file, flat ASCII file, or through a database query or other data transfer mechanism. Results may be posted to an sftp site, emailed, or acquired through a Web service or other direct data transfer.

An end user may elect to import this file into a management system or to read it directly on a personal computer to review results. One example of this method is shown in Table 6.

TABLE 6
SAMPLE RESULTS

| | Student | Student | Skill or LM | Skill or LM | | | |
|---|---|---|---|---|---|---|---|
| Date | Name | ID | Node Name | Node ID | Modality | Classroom | Teacher |
| Jun. 27, 2011 | Joe Student | 10101 | Odd Numbers | N0182462 | TI | A108 | Smith |
| Jun. 27, 2011 | Jim Student | 10102 | Odd Numbers | N0182462 | TI | A108 | Smith |
| Jun. 27, 2011 | Jane | 10103 | Odd Numbers | N0182462 | TI | A108 | Smith |
| | Student | | | | | | |
| Jun. 27, 2011 | Bob Student | 10104 | Circles | N0182505 | CL | B100 | Jones |
| Jun. 27, 2011 | Alice | 10105 | Even numbers | N0182545 | VT | C110 | Hess |
| | Student | | | | | | |
| Jun. 27, 2011 | Jess Student | 10106 | Even numbers | N0182545 | VT | C110 | Hess |
| Jun. 27, 2011 | Julia | 10107 | Decimals | N0182545 | IW | C110 | Travis |
| | Student | | | | | | |
| Jun. 27, 2011 | Jimmy | 10108 | Circles | N0182505 | CL | B100 | Jones |
| | Student | | | | | | |
| Jun. 27, 2011 | Seth | 10109 | Odd Numbers | N0182462 | TI | A108 | Smith |
| | Student | | | | | | |
| Jun. 27, 2011 | Matt | 10110 | Decimals | N0182570 | IW | C110 | Travis |
| | Student | | | | | | |
| Jun. 27, 2011 | Glenn | 10111 | Circles | N0182505 | CL | B100 | Jones |
| | Student | | | | | | |
| Jun. 27, 2011 | Brian | 10112 | Odd Numbers | N0182462 | TI | A108 | Smith |
| | Student | | | | | | |
| Jun. 27, 2011 | Jen Student | 10113 | Odd Numbers | N0182462 | TI | A108 | Smith |
| Jun. 27, 2011 | Terry | 10114 | Odd Numbers | N0182462 | TI | A108 | Smith |
| | Student | | | | | | |
| Jun. 27, 2011 | Leigh | 10115 | Circles | N0182505 | CL | B100 | Jones |
| | Student | | | | | | |
| Jun. 27, 2011 | Rick | 10116 | Even numbers | N0182545 | VT | C110 | Hess |
| | Student | | | | | | |
| Jun. 27, 2011 | Anne | 10117 | Decimals | N0182570 | IW | B100 | Travis |
| | Student | | | | | | |
| Jun. 27, 2011 | Lee Student | 10118 | Circles | N0182505 | CL | B100 | Jones |

Assessments

An optional component of the automated assignment platform includes periodic assessment intervals to assess student mastery on each node. For example, the assessments can be administered after each assignment period, daily, weekly, monthly, bi-monthly, etc. In some embodiments the assessments will be given at multiple intervals. Assessments may also be given prior to beginning instruction, using the optimization algorithm to determine the best entry node for each individual student. Assessments may also be given after completion of a learning model to further determine learning gains over the pre-instruction assessment.

Assessments are generated by identifying assessment items (i.e., questions) that align with each content node in the learning progression. A system and method for generating assessments based on learning models with learning targets having pre-cursor and post-cursor relationships is described in U.S. patent application Ser. No. 10/644,061, the disclosure of which is hereby incorporated by reference. Mastery levels are determined either by individual teachers, or through reference to statewide testing standards. Assessment items may be of any type. For example, multiple-choice, true/false, essay or any other type of performance assessment that informs the determination of mastery, partial mastery, or non-mastery. A currently preferred embodiment uses assessment items that are capable of being automatically scored.

Assessment Item Selection Algorithm

The scheduling algorithm can stand alone or can be used in concert with the assessment algorithm. The scheduling and assessment algorithms interact in that the scheduling output is used to identify the learning node to which the assessment items selected by the assessment algorithm for a particular student must be aligned for the next day.

### EXAMPLES

The following non-limiting examples are intended to illustrate certain embodiments of the disclosed invention.

### Example 1

### Learning Model for Middle-School Mathematics

A learning model for Middle-School Mathematics was developed by McGraw-Hill School Education Group through an iterative process. First, experts in mathematics identified a set of core academic standards for sixth-grade mathematics and prioritized them in view of a four-week instructional window. This list of core standards corresponding to the Indiana State Standards was developed to cover the main topics (or strands) in sixth-grade mathematics, i.e., Number Sense and Computation, Geometry and Measurement, and Algebra and Functions. This list of ten standards was then further divided into smaller units. These standards are from the Indiana Department of Education Website. For example, Number Sense and Computation includes “multiply and divide decimals,” which was further subdivided into “multiply decimals” and “divide decimals.” This process was repeated for each of the initially selected ten core standards until twenty-six core skills or “core nodes” were identified.

The learning model was then built by identifying each node that preceded the “core nodes.” These preceding or pre-cursor nodes are those that may need to be known and understood prior to moving on to the next node, i.e., these pre-cursor nodes represent skills that will be needed to master the core node. Each pre-cursor node represents the connections or relationships between nodes in the learning progression. Some of the pre-cursor nodes include some nodes from Grades 4 and 5. Post-cursor nodes include nodes that directly follow a core node and may include skills from Grade 7 or 8. The relationships among the nodes were verified by experts in mathematics.

Individual nodes in the learning model served as the targeted skill for each instructional period or lesson. In some cases, the nodes were too small or too self-contained to be meaningful in the context of an instructional period. As a result, some nodes can be combined and represent slightly larger sizes or skill sets than as originally defined. In sum, sixty-one nodes were identified for the learning progression.

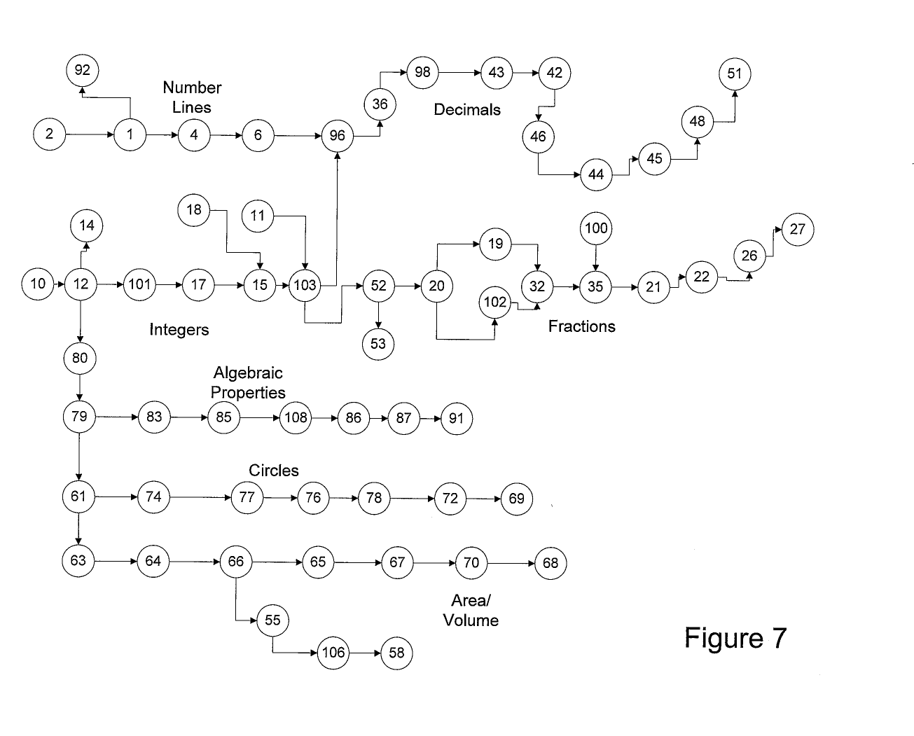

The optimization algorithm assigns students to various nodes and in various groups and time periods. Because it is anticipated that some students may be ahead of others in their peer group, or that a strictly linear learning model may limit the availability of varying modalities for some students and could result in a bottleneck, the learning model nodes were ordered and grouped by strands, i.e., related series of content nodes. Nodes of similar standards were therefore grouped into strands, and the learning model was reviewed so that each strand or group of nodes might be prioritized within the algorithm so that the instruction follows a logical path. For example, algebraic functions would not be taught prior to labeling numbers on a number line. The 61 nodes naturally grouped by concepts. The concepts were ordered in terms of progressive mathematical concepts in the order of 1) number line, 2) integers and fractions, 3) decimals, 4) algebraic properties, 5) area and volume, and 6) circles. The learning model was thus organized as shown in FIG. 7.

This learning model is then reviewed by teachers who will actually implement the learning progression. The teachers may adjust the learning model using professional judgment and experience as necessary.

### Example 2

### Creation of Daily, Weekly, and Pre- and Post-Testing Assessments

Assessments were generated using the Acuity formative assessment system (a McGraw-Hill system). Items were identified that aligned to each of the nodes in the learning progression, and two parallel test forms of four multiple-choice or gridded-response items each were automatically built by a test assembly model for the daily assessments. The results were manually verified. Mastery performance on the daily assessments was defined as three out of four items correct, although a person of ordinary skill will recognize that this assessment is adjustable. Three 15-item weekly assessments were also built that each covered approximately one-third of the learning progression, where the first weekly test covered the first third, the second weekly assessment covered the second third, and the third weekly assessment covered the third. In addition, two parallel test forms were built to serve as the pre- and post-tests. These 30-item test forms included multiple-choice and gridded-response items, and were created based only on nodes within the learning progression. The proportional emphasis of the pre- and post-tests reflected the state-level summative assessment.

### Example 3

### Implementation of the Automated Assignment Platform for Middle-School Mathematics

A middle school uses the assignment platform to optimize available resources for its middle-school math program for one hundred students. Prior to launch, configuration is set such that four classrooms are available with seats for thirty students each and a computer lab is available with fifteen computer seats. Four general-education teachers and one special-education teacher are available during the assignment period. Modalities to be used include teacher-led instruction, virtual tutoring, computer-aided instruction, and intervention. Preferences are given by the school administrators for the order of modalities students should be assigned depending on mastery status, such that teacher-led instruction will be used for first exposure to a learning node, virtual tutoring for second exposure to a learning node, and intervention must be assigned after a student has failed a node twice. One assignment schedule is desired per day so that the mathematics program fits into a typical middle-school schedule.

A learning progression aligned to state standards and available instructional materials is constructed by teachers as in Example 1.

Students are given a pre-test to determine mastery of nodes on the learning progression. A data file (e.g., xml) including the desired learning progression nodes, pre- and post-cursor relationships, student identification, and mastery of any nodes is uploaded to an sftp site from the user to the data pre-processing module. The file is recognized by the data pre-processing module, and data pre-processing automatically begins. Student mastery information is loaded to the database, available nodes for learning are identified for each student, and utilities are calculated as part of the data pre-processing. The information is automatically sent to the optimization module, which recognizes the file and automatically begins the CPLEX or other solver. Assignments of students to nodes, modalities, classrooms, and teachers are passed to the post-processing module and a schedule is prepared as a data file for export.

The school administrator pulls the export file from the sftp site and views the student assignments via Excel and shares the scheduled assignments with teachers and students for the next learning session.

At the end of the learning session, students are given a short assessment of six items aligned to the learning node administered. Mastery on the learning node is calculated by the testing platform based on the number of correct responses given on the items. Mastery information is prepared in the input file for the assignment platform for the subsequent period.

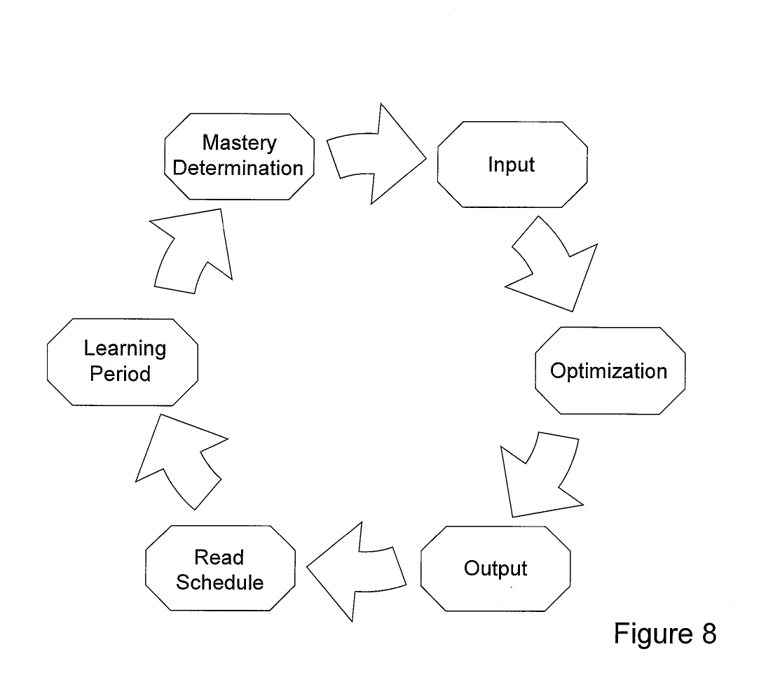

The input→optimization→output→read schedule→learning session→mastery determination→input cycle occurs for each subsequent learning session or set of learning sessions as in FIG. 8. Students' progress through the learning progression is individualized based on mastery of each node and the assignment, reflecting the maximum utility given the constraints.

### Example 4

### Use of Shared Resources and School Planning

The invention may be used in any context in which shared resources are allocated among students with a desire to optimize an aspect of the student experience, such as learning opportunity or gain for the student, or optimize school resource use, such as number of teachers required to teach a set of students. For example, a school district may use the invention to allocate a special services teacher (e.g., special education teacher, English Language Learner teacher, school psychologist, speech therapist, music teacher, physical education teacher) among multiple school sites. Additionally, a single school site may use the invention to allocate expensive assistive technologies to students, or to minimize the number of modular classroom units required to augment building space in high population schools.

Persons of ordinary skill will recognize that the invention may also be used for school planning. Simulation of scenarios through the scheduling algorithms can provide information to school administrators in advance, such as when they can expect to require additional teachers to support students needing evaluation and enrichment, when or if they can expect to require additional computer workstations for students, or how many virtual tutors they should budget for the year, for example. Simulation can also help to predict how many students will finish curriculum early in the school year and be ready for new learning opportunities, and how many students will struggle to meet the minimum curriculum requirements by the end of the school year.

### Example 5

### Complex Performance Events

Complex performance events are increasingly being utilized in the classroom embedded as instruction and as part of assessments. More formal implementations of performance tasks within standardized assessments require evidence that each student had similar opportunities to respond to the event. Thus, validity evidence is supported by assuring that each student has access to all components of a performance event. For example, an experiment may require a student to gather data from one setting through observation or application, use the data gathered to modify a design or simulation conditions, apply design modifications to virtual computer based or real world environments, conduct tests using modifications in virtual or real world settings, and document results in text, tables, and figures. This example describes the use of multiple resources (human, settings, and equipment) which may be in limited supply. Thus, the use of the current invention may support the validity of performance assessments by providing solutions to support optimal student engagement of all requirements of the performance event.

### Example 6

### Effectiveness Measurement through Randomized Controlled Research

Finally, the invention may be used to conduct randomized controlled experiments intended to measure curriculum, program, and/or teacher effectiveness, for example. Students with matched ability and/or other relevant demographic qualities can be randomly assigned to the treatment and control groups, and scheduled to receive these treatments through the normal course of the school day. The algorithm may also be used for the purpose of teacher evaluation, especially accompanied with experimental design method. For example, students may be randomly assigned to different teachers while controlling other variables the same, such as nodes, modality, and lesson plans. Using such experimental design, the effectiveness of teaching from different teachers may be compared without the noises. To the inventors' knowledge, this is a novel application and resolves many of the challenges faced by the education industry when trying to measure program, product, or individual effectiveness.

1-10. (canceled)

11. A computer-implemented method for automated optimization of learning content delivery and learning resource allocation comprising:
(a) identifying a plurality of input data;
(b) pre-processing said plurality of input data via a data pre-processing module into a series of possible input data combinations;
(c) assigning a utility value to each possible data combination;
(d) utilizing said utility values to optimally allocate learning resources and learning content for one or more students via a mathematical optimization algorithm;
(e) generating an assignment schedule reflecting said optimal allocation for said one or more students; and
(f) exporting said assignment schedule to an end user.

12. The computer-implemented method of claim 11, wherein said input data includes one or more learning models, one or more learning modalities, and one or more learning constraints.

13. The computer-implemented method of claim 11, wherein said data pre-processing step comprises the steps of:
a) identifying each student available for scheduling;
b) identifying learning content available for each student; and
c) identifying the mastery status of said learning content for each student.

14. The computer-implemented method of claim 11, wherein said data-preprocessing further comprises storing data wherein data corresponding to one or more students and said one or more students' learning progression data is stored.

15. The computer-implemented method of claim 11, wherein said mathematical optimization algorithm is configured to generate an optimal allocation of learning resources and learning content for one or more learning periods.

16. The computer-implemented method of claim 11, further comprising a data post-processing step, occurring after said assignment schedule is generated, wherein the allocation of learning resources and learning content for each said one or more students' assignment schedule is stored in a data store, and wherein the optimization algorithm may utilize the stored allocation of learning resources and learning content to automatically weight said utility values assigned by the pre-processing step to adjust the likelihood that the optimization algorithm will assign a particular data combination.

17. The computer-implemented method of claim 11, further comprising:
assigning a utility values in the pre-processing step to adjust the likelihood that the optimization algorithm will assign a particular data combination.

18. The computer-implemented method of claim 15, further comprising controlling with said mathematical optimization algorithm, the interaction between:
(a) a mathematical model file that includes at least mathematical formulas and at least configuration information required to solve said optimization algorithm;
(b) a resource configuration file that includes input data reflecting learning resource and learning delivery constraints; and
(c) a student-learning content utility file that includes an identifier for said one or more students, the possible learning content available to the one or more students, and the utility value assigned to each combination of student and learning content.

19. The computer-implemented method of claim 11, further comprising utilizing learning assessments in conjunction with said mathematical optimization algorithm to generate input data.

20. The computer-implemented method of claim 11, further comprising enabling said assignment schedule to be manually varied by an end user from the assignment schedule reflecting said optimal allocation for one or more students into an alternate configuration.

21. The computer-implemented method of claim 18, further comprising automatically updating said resource configuration file and said student-learning content utility file based on a determination of mastery or non-mastery for each student-learning content combination.

22. A computer-implemented method for automated optimization of learning content delivery and learning resource allocation comprising:
(a) identifying input data comprising a plurality of students to be assigned a schedule, the learning content available to be assigned to said plurality of students, and the learning modalities available to teach said plurality of students said learning content;
(b) pre-processing said input data to generate one or more student-learning content-learning modality combinations for each student;
(c) assigning each student-learning content-learning modality combination a utility value;
(d) utilizing a mathematical optimization algorithm to generate an assignment schedule by selecting a student-learning content-learning modality combination that maximizes the total sum of utility values for all students;
(e) storing each selected student-learning content-learning modality combination in a data store;
(f) exporting said assignment schedule to an end user; and
(g) updating said stored student-learning content-learning modality combination to reflect mastery or non-mastery of said student-learning content-learning modality combination following each student mastery attempt.

23. The computer-implemented method of claim 22, further comprising enabling said assignment schedule generated by selecting a student-learning content-learning modality combination that maximizes the total sum of utility values for all students to be manually varied by an end user into an alternate configuration.

24. The computer-implemented method of claim 22, further comprising enabling said optimization algorithm to utilize stored mastery or non-mastery determinations for each student-learning content-learning modality combination to automatically weight said utility values to adjust the likelihood that the optimization algorithm will select a particular learning content-learning modality combination to an individual student.

25. A computer-implemented method for automated optimization of learning content delivery and learning resource allocation to a plurality of students, wherein the learning content comprises a plurality of learning targets, said method comprising:
A. providing, as input, data relating to:
1. learning modalities for delivering instruction relating to learning content
2. learning resources available for delivery of the instruction;
3. at least one learning model for the content which expresses interrelationships between the learning targets;
4. proficiency status of each student for each of the learning targets of the content;
B. with a computerized optimization algorithm, manipulating the input data provided in step A to automatically generate, for each student, a schedule of learning content delivery comprising:
1. at least one unlearned learning target for which the student is not presently proficient;
2. a learning modality by which instruction relating to said unlearned learning target will be delivered to the student; and
3. a learning resource with which instruction relating to said unlearned learning target will be delivered to the student;
C. delivering instruction relating to the unlearned learning target to each student in accordance with each student's schedule generated in step B;
D. after step C, assessing each student's proficiency in the unlearned learning target included in the schedule generated in step B; and
E. updating the input data relating to the proficiency of each student for the unlearned learning target.

26. The method of claim 25, further comprising, after step E, repeating steps A through D at least one time.

27. The method of claim 26, wherein, if the student is determined in step D to be non-proficient in the unlearned learning target, the input data is adjusted when step A is repeated to increase the likelihood that the schedule generated when step B is repeated will comprise the same unlearned learning target with at least one different learning modality or learning resource.

28. The method of claim 26, wherein, if the student is determined in step D to be proficient in the unlearned learning target, the input data is adjusted when step A is repeated to increase the likelihood that the schedule generated when step B is repeated will comprise a new, unlearned learning target for which the student is not presently proficient.

29. The method of claim 25, further comprising assigning a unique utility value for each learning modality for each learning target such that when the input data is manipulated during step B, the magnitude of the utility value will influence the likelihood that the schedule will include a particular learning modality for a particular learning target.

30. The method of claim 29, wherein if the student is determined in step D to be non-proficient in the unlearned learning target, the utility value assigned to each modality for the unlearned learning target is adjusted to influence the likelihood that a subsequently generated schedule will include a different learning modality for delivering instruction relating to the unlearned learning target.

31. The method of claim 25, wherein the input data relating to learning resources available for delivery of the instruction comprises constraints applied by the computerized optimization algorithm in step B to influence the likelihood that the schedule will include a particular learning resource.
